(19) United States
(12) Patent Application Publication
(10) Pub. No.: US 2008/0187729 A1
(43) Pub. Date: Aug. 7, 2008

(54) Method of printing a data carrying mark on an unfinished ceramic structure, and structures marked thereby

(76) Inventors: L. Urdenis Johnson, Tyrone, PA (US); Joseph James McIntosh, Painted Post, NY (US)

Correspondence Address: CORNING INCORPORATED, SP-TI-3-1, CORNING, NY, 14831, US

(21) Appl. No.: 11/998,599

(22) Filed: Nov. 30, 2007

Related U.S. Application Data
(60) Provisional application No. 60/861,914, filed on Nov. 30, 2006.

(51) Int. Cl. B32B 18/00; B05D 3/02

(52) U.S. Cl. 428/210; 427/287

(57) ABSTRACT

A method for printing a data-carrying mark on a portion of an unfinished ceramic structure, such as the green body Of a ceramic honeycomb structure; is disclosed that is capable of producing a mark that maintains legibility even after being fired to temperatures above 1100° C. or higher, or even 1300° C. or higher. The data-carrying mark is formed from a deposit of colorant solids overlying a portion of the unfinished ceramic structure. The volume of colorant solids per unit area of marked wall portion that is at least twice as much as that required to obtain maximum pre-fired visual contrast between marked and unmarked portions of the structure (i.e., prior to firing). The colorant solids may include one or more of cobalt, nickel, iron, chromium, copper, manganese and titanium, either in metallic or oxide form, and are preferably deposited in particulate form via a high temperature ink composition that prints the data-carrying mark by way of an ink jet print head. The data-carrying mark may be a digital pattern of marked and unmarked wall portions such as a bar code.

This application claims the benefit of U.S. Provisional Application No. 60/861,914, filed Nov. 30, 2006, entitled “Method of Printing a Data Carrying Mark on an Unfinished Ceramic Structure, and Structures Marked Thereby.”

### FIELD

This invention generally relates to providing marking on ceramic articles, and is specifically concerned with a method for printing a data-carrying mark on an unfinished ceramic structure which is capable of maintaining legibility after being subjected to firing temperatures, and the resulting marked structures.

### BACKGROUND

Ceramic honeycomb structures are widely used as anti-pollutant devices in the exhaust systems of automotive vehicles, both as catalytic converter substrates in automobiles, and diesel particulate filters in diesel-powered vehicles. In both applications, the ceramic honeycomb structures are formed from a matrix of thin ceramic webs which define a plurality of parallel, gas conducting channels. In honeycomb structures used as ceramic catalytic substrates, the cell density may be as high as about 900 cells per square inch. To reduce the pressure drop that the exhaust gases create when flowing through the honeycomb structure, the web walls are rendered quite thin, i.e. on the order 2-6 mils. Ceramic honeycomb structures used as diesel particulate filters have a lower cell density of between about 100 and 400 cells per square inch, formed from webs on the order of 12-25 mils thick. In both cases, the matrix of cells is preferably surrounded by an outer skin which is also quite thin.

Such ceramic honeycomb structures may be formed by an extrusion technique in which a plasticized batch including precursor ceramic compositions to cordierite, aluminum titanate, or silicon carbide, for example, are extruded into a tubular body that is cut into segments that form green ceramic bodies. These green bodies are fired at temperatures of at least 1100° C., and typically 1300° C. or higher in order to sinter the particles of precursor ceramic compositions present in the extruded material, and form the cordierite, aluminum titanate, or silicon carbide ceramic honeycomb structure. These fired ceramic structures may be subjected to a coating process that coats the gas contacting surfaces with a washcoat, which may contain catalytic metals. The washcoated structures may be subjected to additional heating steps, such as a calcining step, in order to remove any organic compounds deposited as a result of the washcoating operation. In such a calcining step, the washcoated ceramic structures are fired again at a lower temperature on the order of 550° C. more. In this application, the term “unfinished” ceramic structure refers to a precursor ceramic structure that has not completed all of its firing steps, including a dried green body, an unfired or only partially fired green body, or a completely fired green body that has not undergone a calcining step or other step requiring a further firing.

Unfortunately, due to the thinness of the outer skin and the inner cell-forming webs, the substantial thermal stresses that the unfinished ceramic structures undergo during the firing processes, and the necessary mechanical handling of the green and fired bodies during the manufacturing process, defects such as internal cracks and voids may occur, as well as separations between the outer skin and the inner matrix of webs. In addition, certain target properties such as porosity and median pore size are desired. In order to determine the possible causes of such defects and variations in such target properties, it is desirable to have a quality control procedure which allows the manufacturer to reliably trace any defective or variant ceramic honeycomb structure back to the specific factory, kiln, and batch that it originated from. Such a procedure would allow the manufacturer to review the particular manufacturing parameters used to fabricate the structure and to modify its manufacturing operation in order to reduce the occurrence of such defects in future articles. Accordingly, it is a known procedure to mark, after the final firing or heating step, finished ceramic honeycomb structures with marks containing manufacturing information so that remedial manufacturing operations may be implemented.

While such a prior art procedure can provide useful information for quality control, the applicants have observed that such a marking procedure may not, under certain circumstances, reliably result in an accurate recovery of the manufacturing information associated with a particular ceramic honeycomb structure. In particular, the applicants have observed that subsequent to the manufacture of the green bodies of such structures, different batches of green bodies from different kilns often become mixed together in order to efficiently implement other stages of the fabrication process. Hence a quality control process where manufacturing information is printed on the finished ceramic honeycomb structures may not accurately reflect the actual manufacturing conditions, and history of the structures.

To avoid the aforementioned problem, it is necessary to print a data carrying mark on the green bodies that ultimately form the finished ceramic honeycomb structures. However, there are a number of problems associated with implementing such a method due to both the fragility of the green bodies, the high temperatures they are subjected to during the firing process, and the speed with which they must be marked in order to avoid a production bottleneck. While high temperature inks for marking ceramic articles are known, there presently exists no known way to use such inks to quickly and efficiently print a data-carrying mark that remains legible after exposure to firing temperatures which may be in excess of 1300° C. Furthermore, even at lower firing temperatures, achieving sufficient post-firing mark contrast is a significant problem.

Accordingly, there is a need for a data-carrying mark which may be printed on the wall of a green body or other unfinished ceramic structure which is capable of withstanding firing temperatures of at least 1000° C., and more preferably 1300° C. or higher without losing any data. Ideally, such a mark would be rapidly and easily printed on the side of a dried green body or other unfinished ceramic structure by way of a known, non-contact printing technique. It would be desirable if commercially available, high temperature ink compositions could be used to produce such a data-carrying mark. The ink used to form the mark should be nontoxic and chemically compatible with the unfired ceramic material forming the body, and should not create excessive thermal stresses during firing. The ink should not blur or run when printed, and should have similar thermal expansion and contraction properties so as to create a clear mark that does not crack or peel during the firing and cooling steps of manufacture. The ink should not degrade or react with the ceramic material forming the wall of the structure during any phase of the manufacturing process, and should visibly contrast against the wall of finished articles formed from either cordierite or aluminum titanate, even after the application of a catalytic washcoat. Finally, the resulting mark should be capable of providing a substantial amount of manufacturing data, such as the date of manufacture, and the specific factory, kiln, and batch can be accurately trace, and should be robust enough so that the information contained in the resulting mark is maintained even if a portion of the mark is obliterated during the use of the ceramic honeycomb structure.

### SUMMARY

Generally speaking, the invention includes both a method for printing a data carrying mark on a portion of an unfinished ceramic structure, as well as the resulting marked unfinished and finished ceramic structure. As set forth in detail hereinafter, the invention overcomes the aforementioned shortcomings associated with the prior art.

The invention stems from the applicants' observations that the after-fired legibility of a data-carrying mark printed with a heat resistant ink via a non-contact printing technique may be maintained only if the volume of deposited, solid particulate colorants forming the mark is multiples more than the amount required to achieve maximum visual contrast in the unfired state (i.e., maximum pre-fired visual contrast). In particular, for dried green bodies exposed to firing temperatures of at least 1100° C., and more typically 1300° C. or more, the volume of solid colorants should be at least twice as much as that required to obtain a maximum pre-fired visual contrast between a marked and an unmarked portion prior to firing, or even three or four times as much, or more. The invention is particularly applicable to green bodies of ceramic honeycomb structures formed from cordierite, aluminum titanate or silicon carbide that are used to make automotive catalytic converters and exhaust system particulate filters.

The method of the invention generally comprises the steps of printing, via a non-contact printing operation, a data-carrying mark on an unfinished ceramic structure by depositing a high temperature ink on a wall of the unfinished ceramic structure until the volume of deposited, solid particulate colorants forming the mark is at least twice that needed to obtain a maximum pre-fired visual contrast between a marked and an unmarked portion of the structure, such as a outer peripheral wall. In the preferred method of the invention, volume of deposited, solid particulate colorants is at least three times the volume needed to achieve maximum pre-fired visual contrast on the unfired wall portion. The non-contact printing operation is also preferably a high speed printing operation in order to avoid production bottlenecks, such as ink jet printing.

The solid particulate colorants of the high temperature ink may be formulated to include one or more of the group consisting of cobalt, nickel, iron, chromium, copper, manganese and titanium, either in metallic or oxide form. The particulate colorants may be mixed with a carrier liquid to form a printable ink. The average particle diameter of the solid colorants may be, for example, between about 0.1 and 8 microns, or even between about 0.3 and 2 microns, and the carrier liquid may be an organic liquid that does not react with the ceramic material forming the structure, such as methyl ethyl ketone.

The solids loading of the ink is preferably between about 10% and 20% of particulate colorant volume to liquid carrier volume, and is more preferably between about 12% and 18%. The viscosity of the ink may be between about 8 and 15 pascal-seconds at ambient temperature. An ink with a lower solids loading makes it more difficult to achieve the necessary amount of colorant solids per unit area of the mark, while an ink with a higher solids loading is more apt to clog commercially available ink jets, and to abrasively wear down the inner diameters of such ink jets. To counteract the tendency of the particulate colorants to settle in the liquid component, the ink may be agitated during printing in order to keep the particulate colorant uniformly in suspension during the printing operation. Finally, to efficiently achieve the desired volume of colorant solids per unit area in the resulting mark with ink jet printing techniques utilizing ink having a solids loading of between 10% and 20%, the method of the invention may also include the steps of multiple-pass printing, slow single pass printing, increased ink droplet frequency, or the use of an angled, multiple-jet print head to increase the density of deposited ink droplets.

While the data-carrying may comprise a single discrete deposit of solid colorants in, for example, the shape of a single alpha-numeric character, the mark of the invention preferably comprises a digital pattern of marked and unmarked portions, such as on a wall, the marked portions being formed by discrete deposits of solid colorants at the aforementioned volume per unit area, the unmarked portions having either no deposit or a substantially less deposit such that, after firing, the marked portions provide a perceptible contrast with the unmarked portions. The pattern of marked an unmarked wall portions may be arranged in the form of a barcode, for example. According to embodiments, the barcode is a machine-readable, two-dimensional data matrix barcode that includes unique manufacturing information relating to the specific ceramic structure that it is printed on, such as the identification of the specific factory, kiln, batch number, date of green body manufacture, and an individual identification number. Such a unique barcode is preferably printed on each ceramic honeycomb structure. The use of a two dimensional matrix bar code provides a robust record of the information contained within the mark since as much as 30% of the mark can be obliterated without loss of information. In addition to the machine-readable bar code, the mark may also includes a human-readable, alpha-numeric data string to facilitate extraction of the data when a bar code reader is not available.

According to another aspect, the invention is a marked unfinished ceramic structure, comprising an unfinished ceramic structure, and a mark on a portion of the structure, wherein said mark comprises a deposit of solid particulate colorants wherein a volume of particulate colorant solids per unit area of the mark is at least about twice as much as is necessary for a pre-fired maximum visual contrast between said mark and an unmarked portion of said structure.

Finally, the invention also includes a finished ceramic structure having a mark on a portion thereof formed from a deposit of colorants that is at least twice as thick as that which is necessary to obtain a maximum visual contrast in the unfinished ceramic structure.

### DESCRIPTION OF THE DRAWINGS

FIG. 1A is a perspective view of an unfinished ceramic honeycomb structure that has been marked with a data-carrying mark in accordance with the method of the invention;

FIG. 2A is an enlargement of the data-carrying mark illustrated on the side of the unfinished ceramic honeycomb structure illustrated in FIG. 1;

FIG. 2B is a side, cross-sectional view of the marked wall portion illustrated in FIG. 2A along the line 2B-2B;

FIG. 2C is an enlargement of the area circled in phantom in FIG. 2B, illustrating in particular the layer of solid particulate colorants that must be deposited on a portion of the side wall of the an unfinished ceramic structure to carry out the method of the invention;

FIG. 3 is a side view of a marking station for implementing the method of the invention, and

FIGS. 4A and 4B are plan views of the marking station illustrated in FIG. 3 implementing the method of the invention.

### DETAILED DESCRIPTION

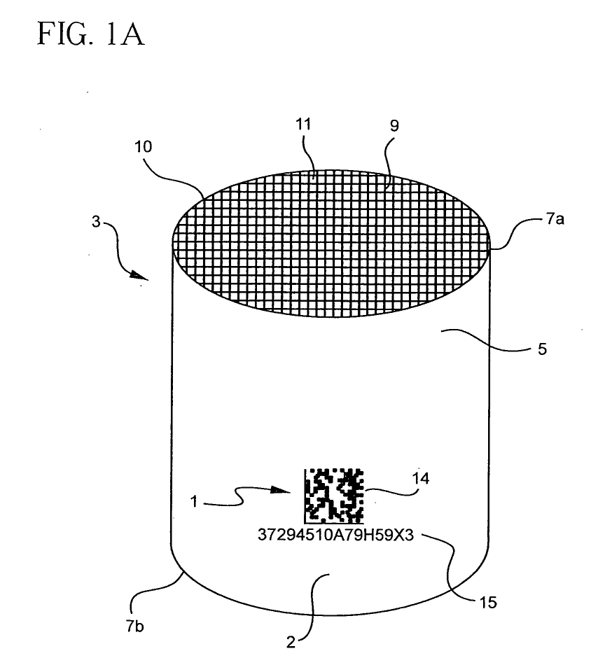

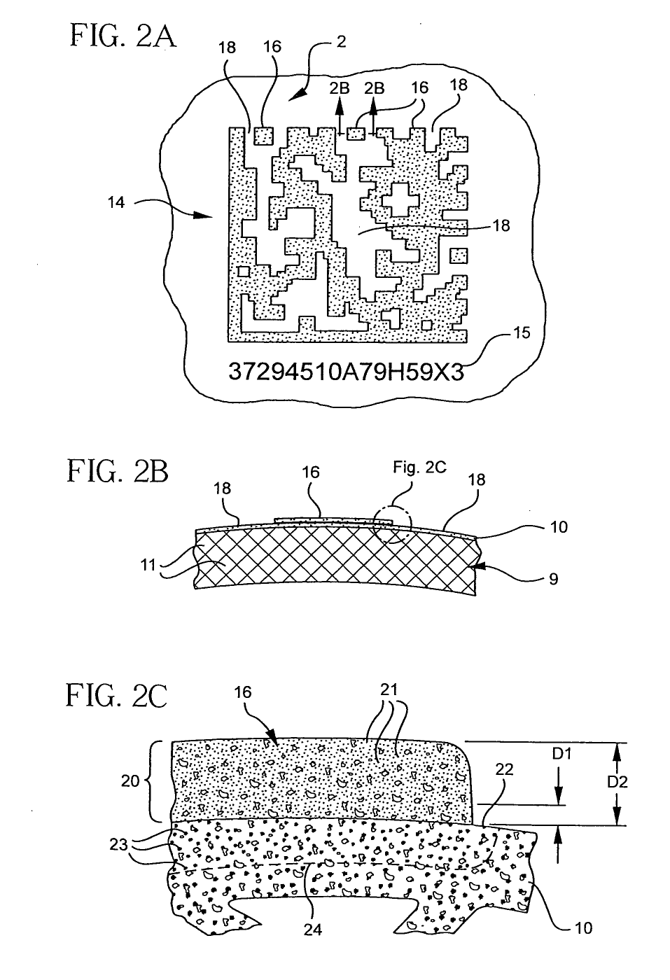

With reference now to FIG. 1, wherein like numerals designate like components throughout all of the several Figures, the invention is a method for printing a data-carrying mark 1 on the side wall 2 of an unfinished ceramic structure 3. In this example, the ceramic structure 3 is an unfinished ceramic honeycomb structure formed from cordierite or aluminum titanate of the type used in automotive exhaust systems, although the invention is not limited to such an application. Such ceramic structures generally have a cylindrical body 5 having open inlet and outlet ends 7a, 7b for receiving and expelling automotive exhaust gases. The interior of such structures 3 includes a grid-like network 9 of integrally connected ceramic webs that define gas-conducting cells 11 (best seen in FIG. 2B) extending between the inlet and outlet ends 7a, 7b.

With reference to FIGS. 1 and 2A, the mark 1 includes a machine-readable component 14 such as a two-dimensional bar code, and a human readable component 15 such as a string of alphanumeric characters. The machine-readable component 14 preferably includes a digital pattern of printed wall portions 16 and unprinted wall portions 18 in order to maximize the optical contrast between the printed and unprinted wall portions 16, 18, thereby reducing the chance of a reading error. The machine readable component 14 may of course be a one dimensional bar code or virtually any type of information carrying pattern of marked and unmarked wall portions 16, 18. However, a two-dimensional bar code is a preferred embodiment of the mark of the invention as up to 30% of such marks can be obliterated without loss of information.

With reference to FIGS. 2B and 2C, the printed wall portions 18 are formed from a layer 20 of particulate colorant solids 21 deposited over the outer surface 22 of the skin 10. The solids 21 are fine particles preferably mixed with a carrier liquid to form a printable ink. The average particle diameter of the solids 21 may be between about 0.1 and 8 microns, and more preferably between about 0.3 and 2 microns. The solids include one or more of the group consisting of cobalt, nickel, iron, chromium, copper, manganese and titanium, either in metallic or oxide form. More preferably, these elements are in oxide form when applied to avoid any potentially negative effects associated with the metal-to-oxide transition that these elements would go through at firing temperatures of 1100° C. or higher, and include in particular cobalt oxide, chromium oxide and nickel oxide. As described in more detail hereinafter, these particulate solids are deposited on the outer surface 22 of the skin 10 in droplets of an ink formed by mixing these solids with a fluid carrier, which is preferably a transparent liquid that is compatible with an ink jet printing operation, and absorbable in, but not reactive with, the porous outer skin 10 of the unfinished ceramic structure 3. An example of such a carrier fluid is methyl ethyl ketone.

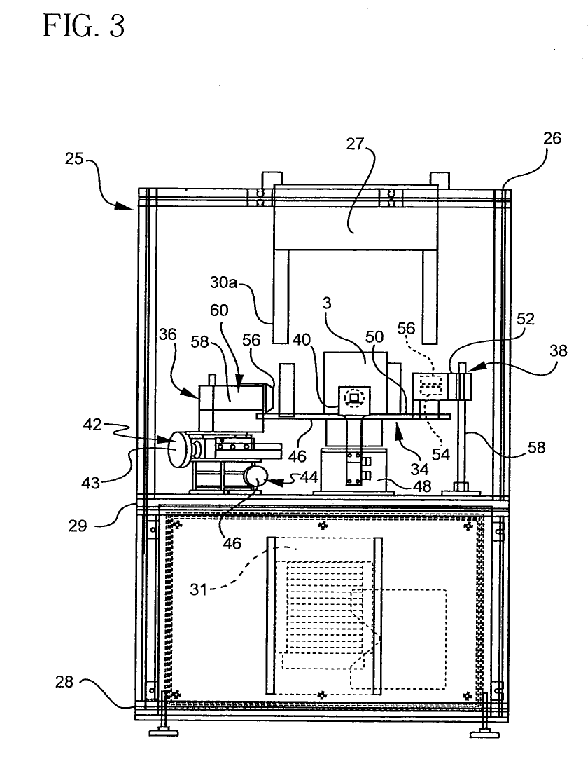

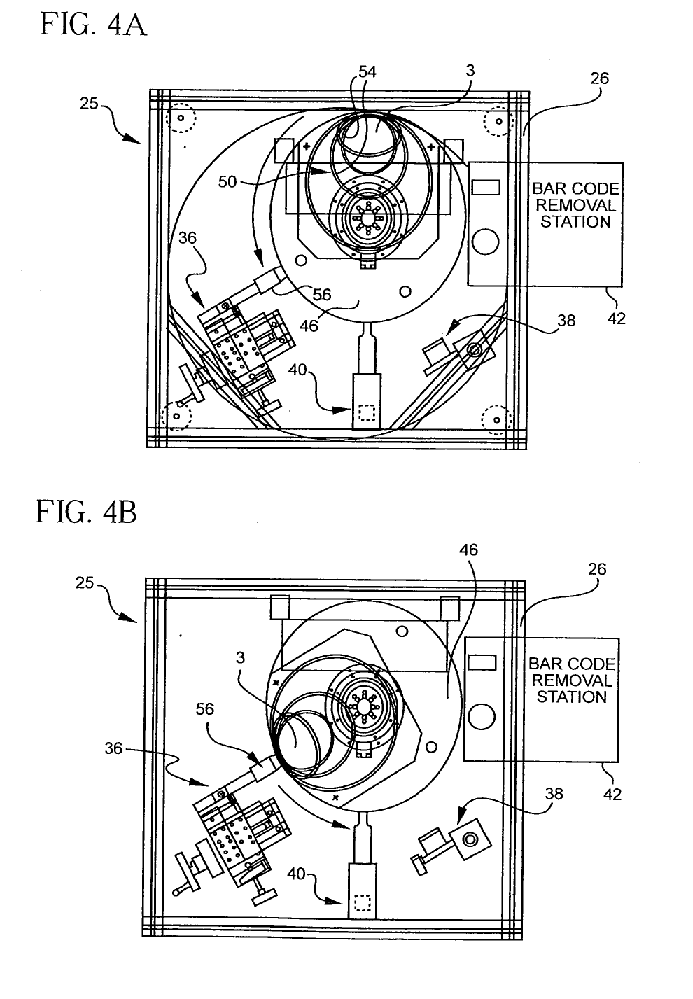

With reference now to FIGS. 3 and 4A and 4B, the green body or otherwise unfinished ceramic structure 3 may be marked in a marking station 25. The marking station 25 may include, for example, an upper frame 26 that slidably supports a crane-like grappling device 27. Marking station 25 may further include a lower shelf 28 and an upper shelf 29. The lower shelf 28 supports a programmable logic controller 31 which controls the operation of the various components mounted on the upper shelf 29. The upper shelf 29 supports a moving assembly 34, a printer 36 for printing the data-carrying mark 1 on an unfinished ceramic structure 3, an optical reader 38 for reading and determining the overall equality of the printed mark 1, a dryer 40 for drying the ink that forms the mark 1, and a bar code removing assembly 42 (shown in FIGS. 4A and 4B) for removing defectively-printed marks from the unfinished ceramic structure 3 in the event of a malfunction Each of these principal components of the station 25 will now be described in more detail.

The moving assembly 34 includes a turntable 46 rotatably mounted on a driver 48. Although not specifically shown in the drawings, the driver 48 is formed from a combination of a step servo motor whose output is connected to the rotatably mounted turntable 46 via a drive train. The step servo motor of the driver 48 is connected to a power source (also not shown) which in turn is controlled by the programmable logic controller 31. The controller 31 controls the specific angle that the turntable 46 rotates by controlling the number of power pulses conducted to the step servo motor in a manner well known in the digital control arts. The moving assembly 34 further includes a template 50 formed from a plate 52 that lies on top of the turntable 46. The plate 52 has a recess 54 which is complementary in shape to the bottom edges of a particular model of green ceramic honeycomb structure 3. The template 50 includes a set of pins (not shown) that position the plate 52 in proper alignment with the top surface of the turntable 46. While the template 50 has been referred to thus far in singular terms, the station 25 preferably includes a plurality of templates 50 (indicated in FIG. 4A), each of which has a recess 54 that corresponds to a different sized ceramic structure 3. All of these templates 50 serve to position their respective ceramic structures 3 such that a side wall of the structure 3 is tangent with the outer periphery of the turntable 46. Such positioning insures that the printer 36 and optical reader 38 will be spaced a proper distance from the side wall 2 of the ceramic structure 3, regardless of the particular size of the ceramic structure 3 being marked in the station 25.

The printer 36 includes an ink jet print head 36 which preferably has at least two ink jets (not shown) so as to be able to expeditiously print both a two dimensional bar code, and a human-readable alphanumeric data string. Printer 36 is provided with an ink reservoir 58 for storing a heat resistive ink which is preferably comprised of a mixture of solid particulate colorants and a transparent carrier liquid as previously described, such as methyl ethyl ketone. The solids loading of the ink is preferably between about 10% and 20% of particulate colorant volume to liquid carrier volume, and is more preferably between about 12% and 18%, and the viscosity of the ink is preferably between about 8 and 15 pascal-seconds at ambient temperature. An ink with a lower solids loading makes it more difficult to achieve the necessary amount of colorant solids per unit area of the mark, while an ink with a higher solids loading is more apt to clog commercially available ink jets, and to abrasively wear down the inner diameters of such ink jets. The ink reservoir 58 includes an agitator 60 for stirring the ink during the printing operation in order to maintain a uniform suspension of the particulate solid colorants in the liquid carrier. The agitator 60 may be any one of a number of mechanical stirring devices, such an ultrasonic vibrator.

The method of the invention will now be described. With reference now to FIGS. 3 and 4A, an unfinished ceramic structure 3, such as the green body of a ceramic honeycomb structure, may be first lowered onto the turntable 46 of the conveyor assembly 34 via the crane-like grappling device 27 into the recess 54 of plate 52. The programmable logic controller 31 next generates a unique data carrying mark 1 to be printed on the side wall 2 of the unfinished ceramic structure 3 that includes a machine-readable component 14 and a human-readable component 15, which may or may not be encrypted. Controller 31 next proceeds to actuate the driver 48 of the turntable 46 to position the sidewall 2 of the structure 3 in front of the ink jet print head 56 of the printer 36, as shown in FIG. 4B. With reference again to FIG. 2C, the programmable logic controller 31 actuates the print head 56 to print a pattern of marked portions 16 on the wall 2 that define the pre-selected machine-readable component 14 and possibly a human readable component 15. The print head 56 accomplishes this by applying droplets of the previously described heat resistant ink on the marked portions 16 until a layer 20 of solid particulate colorants 21 having a thickness of D2 is achieved. The thickness D2 is a multiple of a previously determined thickness D1 necessary to obtain a maximum amount of pre-fired visual contrast between the marked 16 and unmarked 18 wall portions forming the mark 1. In this example, D2 is approximately four times the length of D1.

The amount of ink necessary to create a deposit of particulate colorants 21 having a thickness D1 must be empirically determined for the particular type of unfinished ceramic structure being marked, as it may vary with different compositions of ceramic materials, and even between structures formed from the same ceramic compound. This last consideration can best appreciated with reference to FIG. 2C. Due to the porous nature of the outer skin 10, the applicants have observed that some of the particulate solids 23 are absorbed into a zone 24 adjacent to the upper surface 22 of the skin during the initial printing step due to the wicking action between the carrier fluid of the ink and the porous material forming the skin 10. Since the absorbed particulate solids 23 do not contribute to the legibility of the fired mark, and since the porosity of ceramic structures formed even from the same ceramic material (such as cordierite) can vary, for example, between 25% and 70%, the amount of ink necessary to create a deposit of particulate colorants of thickness D1 can vary considerably. Hence the thickness D1 must be determined empirically for each type of ceramic structure before the amount of ink necessary to create the final layer of thickness D2 can be determined.

On the basis of test results obtained by the applicants, it appears that in most cases a final layer of solid particulate colorants having the desired thickness of D2 cannot be achieved with most commercially available ink jet print heads in a single printing pass at a standard drop per inch (DPI) density using the aforementioned ink having a solids loading of between 10% and 20%. Accordingly, the method of the invention may include at least one of the steps of multiple-pass printing, printing at a substantially higher droplet frequency than is normally used, moving the ceramic structure 3 at a substantially slower rate relative to the print head 56, or angling the print head 56 relative to the wall 2 of the ceramic structure 3 during printing to focus the ejected ink droplets into a smaller area, thereby increasing the number of the droplets relative to the area of the mark. In all cases, care must be taken to avoid running of the ink during the printing step.

While the invention has been described in this section in terms of a marking method for an unfinished ceramic structure, the invention also encompasses a unfinished and finished ceramic structure having a mark on a portion thereof. For example, the marked finished structure formed from a deposit of fused solid, particulate colorants that is at least twice a thick as a layer of the solid particulate colorants necessary to create a maximum visual contrast with unmarked portions of the unfinished structure. According to other aspects of the invention, a marked unfinished ceramic structure is also provided. In this instance the unfinished ceramic structure is provided with a mark on a portion of the structure, such as a peripheral wall (e.g., a skin of a honeycomb article), wherein said mark comprises a deposit of solid particulate colorants wherein a volume of particulate colorant solids per unit area of the mark is at least about twice as much as is necessary for a pre-fired maximum visual contrast between said mark and an unmarked portion of said structure.

Different modifications, additions, and variations of this invention may become evident to the persons in the art. All such variations, additions, and modifications are encompassed within the scope of this invention, which is limited only by the appended claims, and the equivalents thereto.

What is claimed is:

1. A method for marking a ceramic structure with an ink including particulate colorant solids mixed with a fluid, comprising the steps of:
forming a mark by depositing said ink on a portion of an unfinished ceramic structure until the volume of particulate colorant solids per unit area of the mark is at least about twice as much as is necessary for a pre-fired maximum visual contrast between said mark and an unmarked portion of said portion, and
firing said unfinished ceramic structure at a temperature of at least about 1000° C.

2. The method of claim 1, further comprising a step of providing a loading of the particulate solids of said ink forming said mark of at least about 50%.

3. The method of claim 1, wherein the step of firing is at a temperature of at least about 1300° C.

4. The method of claim 1, wherein the step of forming the mark includes a deposit of the ink by two or more applications of an ink having a loading of particulate solid colorants less than 25%.

5. The method of claim 1, wherein the step of forming the mark includes forming a pattern of marked portions and unmarked portions of the unfinished ceramic structure, and wherein the unmarked portions include substantially no ink.

6. The method of claim 5, wherein the step of forming the pattern of marked portions comprises forming bars of a bar code.

7. The method of claim 5, wherein the step of forming the pattern of marked portions comprises forming a two-dimensional bar code.

8. The method of claim 1, wherein the depositing of said ink on said portion defines at least one alpha-numeric character.

9. The method of claim 1, wherein the ink is a mixture of said particulate colorant solids and a liquid.

10. The method of claim 9, wherein said ink is deposited by way of an inkjet printer.

11. The method of claim 9, wherein the particulate solids of said ink form no more than about 25% of the volume of the ink.

12. The method of claim 9, wherein the step of forming the mark includes a first application of the ink, and then a re-application of the ink overtop the first application.

13. The method of claim 1, further comprising a step of formulating the particulate colorant solids include one or more of the group consisting of cobalt, nickel, iron, chromium, copper, manganese and titanium, either in metallic or oxide form.

14. The method of claim 1, wherein upon completion of the firing step, the ceramic structure formed is one of cordierite, aluminum titanate, and silicon carbide.

15. The method of claim 1, wherein the ceramic structure is formed as a ceramic honeycomb structure.

16. The method of claim 1, wherein the particulate colorant solids is selected to have an average particle diameter of between about 0.1 and 8 microns.

17. The method of claim 1, wherein a viscosity of the ink at ambient temperature is formulated to be between about 5-20 pascal-seconds.

18. The method of claim 1, wherein said volume of particulate colorant solids per unit area is achieved with said ink jet printer by one of:
multiple printing passes over said portion,
angling a print head of a printer relative to said portion to increase a density of ink droplets per unit area of said portion, and
adjusting a rate of ink droplets ejected from a print head of a printer.

19. The method of claim 1, wherein the volume of particulate colorant solids per unit area of the mark is at least about three times the amount needed to obtain a maximum pre-fired contrast between said mark and an unmarked portion.

20. A finished ceramic structure, comprising:
a mark on a portion thereof, wherein said mark comprises a deposit of fused, solid particulate colorants, and wherein the thickness of the mark is at least twice as thick as a thickness necessary to obtain a maximum pre-fired visual contrast when the unfused solid particulate colorants are deposited on the ceramic structure in an unfinished state.

21. A marked unfinished ceramic structure, comprising:
an unfinished ceramic structure, and
a mark on a portion of the structure, wherein said mark comprises a deposit of solid particulate colorants wherein a volume of particulate colorant solids per unit area of the mark is at least about twice as much as is necessary for a pre-fired maximum visual contrast between said mark and an unmarked portion of said structure.
